(19) United States
(12) Patent Application Publication
(10) Pub. No.: US 2026/0218588 A1
(43) Pub. Date: Jul. 30, 2026

(54) SOLAR POWERED AIR COMPRESSOR CONFIGURED TO MANAGE MULTIPLE STREAMS OF INSTRUMENT GAS

(71) Applicant: ReadyFlo Systems, LLC, Corpus Christi, TX (US)

(72) Inventors: Brent Busenlehner, Corpus Christi, TX (US); Zach Kokel, Giddings, TX (US)

(73) Assignee: ReadyFlo Systems, LLC, Corpus Christi, TX (US)

(21) Appl. No.: 19/461,521

(22) Filed: Jan. 27, 2026

Related U.S. Application Data
(60) Provisional application No. 63/750,136, filed on Jan. 27, 2025.

(51) Int. Cl. E21B 41/00; H02S 10/12; H02S 10/20

(52) U.S. Cl. CPC E21B 41/00; H02S 10/12; H02S 10/20

(57) ABSTRACT

A system for generation of compressed gas for use by a pneumatic device positioned off-grid or at a wellsite. The system includes primary, secondary, and optionally tertiary supplies of gas, primary and secondary power supplies, flow lines connecting an output from each of the gas supplies, and an output line connectable to the pneumatic system. The primary air supply may be compressed air at a desired pressure, such as generated by an air compressor utilizing solar and/or wind power or utility power. If there is insufficient air pressure from the primary supply, a secondary and then a tertiary supply of gas can be utilized as backup. The secondary supply can be bottled gas or the field gas currently in use at the remote or wellsite. In some instances, the secondary supply may be bottled gas, and a tertiary supply may be wellsite field gas. The secondary power supply may be a generator as a backup to the solar and wind power supply.

### CROSS-REFERENCE TO RELATED APPLICATIONS

This application claims priority to U.S. Provisional Patent Application Ser. No. 63/750,136 filed Jan. 27, 2025, the content of which is incorporated herein in its entirety.

### FIELD OF THE INVENTION

This disclosure relates to systems and methods for providing compressed gas for pneumatic devices using renewable energy sources in combination with backup gas and power sources.

### BACKGROUND

Pneumatic devices have been used in the oil and gas industry for several decades. These devices convert compressed gas into mechanical energy to perform tasks such as valve actuation, material handling (e.g., moving drilling fluids and other materials), and pressure regulation. Because wellsites are often located in remote areas without access to standard utility power, the pressure of natural gas produced on-site has commonly been used to operate pneumatic devices. The natural gas, typically methane, is then vented to the atmosphere. Such instruments are widely used due to their relatively low capital and operating costs, leveraging gas produced directly at the wellsite.

Recent environmental regulations, including the “Methane Emissions Reduction Act,” restrict emissions from pneumatic instruments such as process controllers, liquid dump valves, and pneumatic pumps when natural gas is used as instrument air. These restrictions present particular challenges for remote wellsites lacking access to utility power. While an AC-powered air compressor could replace natural gas for instrument air at sites with electricity, the cost of installing and operating such a system may be prohibitive.

Accordingly, there remains a need for a robust, cost-effective, and environmentally friendly instrument air system suitable for use at remote sites, such as off-grid oil and gas wellsites.

### BRIEF SUMMARY

The systems and methods of the present disclosure solve many of the aforementioned problems by providing a robust, economical instrument air system useful to drive pneumatic equipment at remote sites, such as remote wellsites. The system may be used as the primary means to supply compressed air or as a backup at sites that include utility power.

The system generally comprises a primary supply of gas and a secondary supply of gas and flow lines connecting an output from each of the primary and secondary supplies of gas to an output line connectable to one or more pneumatic devices. In use, the system is configured to use the primary supply of gas until it is depleted, or near depleted, before switching to the secondary supply of gas. Switching from a primary to secondary supply of gas may occur via pneumatic control and pneumatic devices without a controller (e.g., control unit). In some configurations, the system comprises a control unit. As such, the control unit may use logic to ensure that the primary supply of gas is used until it is depleted, or near depleted, before switching to the secondary supply of gas.

The system may comprise a tertiary supply of gas, wherein pneumatic control or the control unit ensure that the secondary supply of gas is used until it is depleted, or near depleted, before switching to the tertiary supply of gas. For example, when the primary supply of gas is depleted or nearly depleted, the control unit of the system or pneumatic control and pneumatic devices may cause a flow of gas to the output line to switch from the primary supply of gas to the secondary supply of gas. When a tertiary supply of gas is included, and the primary and secondary supplies of gas are depleted or nearly depleted, the control unit of the system or pneumatic control and pneumatic devices may cause the flow of gas to the output line to switch from the primary and secondary supplies of gas to the tertiary supply of gas.

The system may comprise an air compressor such that the primary supply of gas may comprise a primary tank and optionally a secondary tank, each configured to contain compressed air generated by the air compressor. The secondary and/or tertiary supplies of gas may comprise either of (i) natural gas from the wellsite, or (ii) a secondary tank configured to contain a compressed gas. In some configurations, the secondary supply of gas may comprise a secondary tank configured to contain a compressed gas, and, when included, the tertiary supply of gas may comprise natural gas from the wellsite.

The air compressor of the system may be powered via a main power unit comprising one or more main solar panels, one or more main wind turbines, or a combination thereof, and a rechargeable main storage battery configured to receive power from the one or more main solar panels, one or more main wind turbines, or the combination thereof. The rechargeable main storage battery may comprise one or more storage batteries or battery cells, referred to hereinafter as the main battery array. Moreover, the main power unit may comprise standard components of a solar or wind powered battery array, such as inverters, charge controllers (e.g., MPPT), and the like.

Should the main power unit fail or not provide sufficient power to the air compressor such that the primary supply of gas becomes depleted or nearly depleted, the control unit of the system may cause the flow of gas to the output line to switch from the primary supply of gas to the secondary supply of gas, and when the primary and secondary supplies of gas are depleted or nearly depleted, the control unit of the system may cause the flow of gas to the output line to switch from the primary and secondary supplies of gas to the tertiary supply of gas. In some configurations, the switching could occur via pneumatic control and pneumatic devices without a controller (e.g., control unit).

Alternatively, or additionally, should the main power unit fail or not provide sufficient power, the air compressor of the system may be powered via an auxiliary power unit comprising one or more auxiliary solar panels, one or more auxiliary wind turbines, or a combination thereof; and a rechargeable auxiliary storage battery configured to receive power from the one or more auxiliary solar panels, one or more auxiliary wind turbines, or the combination thereof. The rechargeable auxiliary storage battery may comprise one or more storage batteries or battery cells, referred to hereinafter as an auxiliary battery array. Moreover, the auxiliary power unit may comprise standard components of a solar or wind powered battery array, such as inverters, charge controllers (e.g., MPPT), and the like.

When an auxiliary power unit is included in the system, the control unit may select and implement (i) a main battery mode wherein the air compressor is powered from the main power unit; or (ii) an auxiliary power mode wherein the air compressor is powered via the auxiliary power unit, wherein the main battery mode is selected when a charge of the main battery array is above a predetermined level, and the auxiliary power mode is selected when the charge of the main battery array is below a predetermined level.

Alternatively, or additionally, the system may comprise a generator generating an output and powered by an engine using any fuel including bottled fuel such as propane or gasoline or natural gas fuel from the well. Alternatively, or additionally, the system may comprise a hydrogen fuel cell configured to generate an electrical output. The output of the generator or fuel cell may be directed to the air compressor and/or to the battery array. For example, the generator output may be coupled to a power distribution system (e.g., one or more controllers, switches, or power management devices) configured to selectively direct electrical power to the air compressor, the battery array, or to both. Such may be useful when solar and/or wind generated power is absent or deficient. When the output from the generator is directed to the battery array, the system may further comprise at least one inverter connected between the generator and the battery array. wherein the inverter is configured to convert DC power to AC power and AC power to DC power.

The control unit may select and implement either (i) battery mode wherein the generator is off, and the air compressor is connected to the battery array; or (ii) a generator mode wherein the generator is on thereby powering the air compressor (a) directly, and/or (b) via the at least one inverter and charging the battery array, wherein the battery mode is selected when a charge of the battery array is above a predetermined level, and the generator mode is selected when the charge of the battery array is below a predetermined level.

In some remote areas, utility power may be unstable or unreliable. Thus, while disclosed as useful at remote locations absent utility supplied electric power, the disclosed system may access utility power to run the compressor and/or generator and/or to charge the battery array. As such, even when a remote site has access to utility power, the disclosed system may provide a failsafe.

Methods of use of the disclosed systems, and computer logic controlling the disclosed systems are also provided.

### BRIEF DESCRIPTION OF THE DRAWINGS

Aspects, features, benefits, and advantages of the embodiments herein will be apparent with regard to the following description, appended claims, and accompanying drawings. In the following figures, like numerals represent like features in the various views. It is to be noted that features and components in these drawings, illustrating the views of embodiments of the presently disclosed system, unless stated to be otherwise, are not necessarily drawn to scale. The systems and methods described herein may be better understood by reference to the accompanying drawing sheets, in which:

FIGS. 1A-1C illustrate block diagrams of various instrument air control systems for remote sites according to various aspects of the present disclosure.

FIGS. 2A and 2B illustrate a schematic diagram of an instrument air control system for remote sites according to various aspects of the present disclosure.

FIGS. 3A and 3B illustrate a schematic diagram of an auxiliary power unit and secondary air for remote sites according to various aspects of the present disclosure.

FIG. 3C illustrates a schematic diagram of an exemplary computing environment of the system according to various aspects of the present disclosure.

FIGS. 4 and 5 illustrate a front perspective view and a side view, respectively, of an exemplary design of an instrument air control system according to various aspects of the present disclosure.

FIG. 6 illustrates a front perspective view of an instrument air control system with a solar panel in the deployed position according to various aspects of the present disclosure.

FIG. 7 illustrates a view of certain elements of the electronic control of the instrument air control system according to various aspects of the present disclosure.

FIG. 8 illustrates a front perspective view of an exemplary design of an instrument air control system according to various aspects of the present disclosure, wherein the system is illustrated in an operational mode.

FIG. 9 illustrates a skid designed to house each of the components of the air control system shown in FIG. 8, wherein the skid is illustrated in a compact configuration.

FIG. 10 illustrates a front perspective view of the instrument air control system shown in FIG. 8 in a compact configuration for storage or shipping.

FIG. 11 illustrates a view of certain elements of the electronic control of the instrument air control system according to certain aspects of the present disclosure.

FIG. 12 illustrates the battery array and certain elements of the electronic control of the instrument air control system according to certain aspects of the present disclosure.

### DETAILED DESCRIPTION

In the following description, various alternative embodiments and implementations of an instrument air control system for remote sites, such as remote wellsites, are provided. More specifically, the present disclosure provides an instrument air control system configured to source gas from supplies other than the field gas, e.g., methane, typically used in the prior art systems. As such, the disclosed systems and methods achieve the EPA objective of minimizing methane emissions without imposing prohibitive burdens on oil and gas producers, as can occur with certain prior art systems that rely on expensively sized battery-powered configurations or require costly well shutdowns.

Before providing a detailed description of the systems and methods of the present disclosure, certain definitions and abbreviations are provided to enhance the reader's understanding. These definitions should be read in light of the remainder of the disclosure and understood by a person of skill in the art. Unless defined otherwise, all technical and scientific terms used herein have the same meaning as would be understood by a person of ordinary skill in the art.

### Definitions and Abbreviations

Various aspects of the systems and methods of use thereof disclosed herein may be illustrated by describing components that are coupled, attached, and/or joined together. As used herein, the terms “coupled,” “attached,” and/or “joined” are interchangeably used to indicate either a direct connection between two components or, where appropriate, an indirect connection to one another through intervening or intermediate components. In contrast, when a component is referred to as being “directly coupled,” “directly attached,” and/or “directly joined” to another component, there are no intervening elements shown in said examples.

Various aspects of the systems and methods of use thereof disclosed herein may be illustrated with reference to one or more exemplary implementations. As used herein, the term “exemplary” means “serving as an example, instance, or illustration,” and should not necessarily be construed as preferred or advantageous over other variations of the systems, devices, and methods disclosed herein. “Optional” or “optionally” means that the subsequently described component, event, or circumstance may or may not be included or occur, and the description encompasses instances where the component or event is included and instances where it is not.

Furthermore, throughout the specification, reference to “an aspect” or “certain aspects” means that a particular described feature, structure, or characteristic is included in at least one configuration or version of the system or method. Thus, appearances of the phrases “in one aspect,” “in an aspect,” or “in certain aspects” in various places throughout this specification are not necessarily all referring to the same configuration or version. Those skilled in the art will recognize that the various versions of the systems and methods disclosed herein can be practiced without one or more of the specific details or with other methods, components, materials, etc. In other instances, well-known structures, materials, or operations are not shown or not described in detail to avoid obscuring aspects of the various configuration or versions of the system or method.

Certain terminology is used in the following description for convenience only and is not limiting. The words “lower,” “upper,” “bottom,” “top,” “front,” “back,” “left,” “right” and “sides” designate directions in the drawings to which reference is made but are not limiting with respect to the orientation in which the various parts of the systems and devices disclosed herein may be used unless otherwise indicated.

It must also be noted that as used herein and in the appended claims, the singular forms “a,” “an,” and “the” include the plural reference unless the context clearly dictates otherwise. For example, reference to “a” gas, “an” auxiliary battery array, or “the” compressor should be understood to be reference to one or more of any of these components and/or any other components described herein can be used.

Unless defined otherwise, all technical and scientific terms used herein have the same meanings as commonly understood by one of ordinary skill in the art.

The use of “or” means “and/or” unless specifically stated otherwise, even though “and/or” may be explicitly used in certain instances.

All numerical quantities stated herein are approximate, unless indicated otherwise, and are to be understood as being prefaced and modified in all instances by the term “about.” The numerical quantities disclosed herein are to be understood as not being strictly limited to the exact numerical values recited. Instead, unless indicated otherwise, each numerical value included in this disclosure is intended to mean both the recited value and a functionally equivalent range surrounding that value.

All numerical ranges recited herein include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

As generally used herein, the terms “include,” “includes,” and “including” are meant to be non-limiting. As generally used herein, the terms “have,” “has,” and “having” are meant to be non-limiting.

In this disclosure, field gas, methane, natural gas, and well gas are used interchangeably. The term “alternate energy source” refers to any energy source other than utility supplied or onsite facility supplied. Thus, an alternate energy source could include facility generator supplied electric power, wherein the generator is powered via batteries charged from solar, wind, or other alternate sources.

As used herein, the term “battery array” may refer to a single rechargeable battery, or may refer to an energy storage assembly comprising a plurality of individual battery units electrically connected in series, in parallel, or in a combination thereof, and configured to store electrical energy generated by one or more power sources and to selectively deliver stored electrical energy to one or more loads. The battery array may be configured to provide a desired voltage, current, capacity, or power output appropriate for the intended application. In some implementations, a battery array may be operatively coupled to at least one renewable energy source, such as a photovoltaic array or a wind turbine, and may include associated power management components, including charge controllers, inverters, battery management systems, protective circuitry, or monitoring devices. The individual battery units of the battery array may be of the same or different chemistries, capacities, or form factors, and may be modular, replaceable, or scalable.

As used herein, a “compressor” includes any device configured to receive a gaseous fluid at a first pressure and discharge the gaseous fluid at a higher pressure, including, without limitation, reciprocating, rotary, screw, scroll, centrifugal, and diaphragm compressors, whether electrically, pneumatically, or mechanically driven. When the gaseous fluid is air, the compressor is typically referred to as an air compressor. “Instrument air system” refers to a system that provides compressed air for operating pneumatic devices, controls, and valves at a wellsite, industrial facility, or any other location that includes use of pneumatic devices. Instrument air systems may utilize on-site gas, electrically powered compressors, or hybrid arrangements to supply the required pneumatic power.

As used herein, “compressed gas” is defined as free gas that has been compressed into a volume that is smaller than the volume the gas normally occupies at normal atmospheric pressure. Controlled expansion of the compressed gas can be used as a source of power to operate a wide range of pneumatically powered valves and tools, including, for example, pneumatic controllers, pumps/valves, valve actuators, and separators.

As used herein, “control unit” refers to a combination of memory and a processor configured to store and execute computer instructions. Control unit may include “programmable logic controller” or PLC. A PLC may control the functions of the system, perform datalogging, and communicate with any site master controller. A PLC may also allow monitoring and trending of system process conditions including, but not limited to, run status of the solar panels, wind turbines, generator, run time, voltage and current, charge and voltage state of the battery array(s), system or component temperature, run time of the air compressor, volume of air used, and the like. The PLC may be integrated into a supervisory control and data acquisition (“SCADA”) system that allows for remote operation and monitoring of the system, emits alerts in the event of a fault, and enables generation of carbon credits through reporting of required data in compliance with government regulations.

As used herein, an “inert gas” refers to a gas that is substantially non-reactive under the conditions of use within the disclosed systems and methods, such that the gas does not chemically react, or reacts only to a negligible extent, with system components, process materials, or the surrounding environment. Inert gases may include, but are not limited to, noble gases (e.g., nitrogen, argon, helium, or neon) and other gases that are rendered functionally inert by operating conditions such as pressure, temperature, or concentration. Examples of functionally inert gases at a wellsite include, but are not limited to, nitrogen (N₂), argon (Ar), helium (He), carbon dioxide (CO₂), and mixtures thereof, as well as other gases that are non-flammable and substantially non-reactive with hydrocarbons, water, metals, elastomers, and seal materials under wellsite operating conditions of pressure and temperature.

“Hydrogen fuel cell,” as used herein, refers to an electrochemical energy conversion device configured to generate electrical power by reacting hydrogen with an oxidant, such as oxygen or air, without combustion. The hydrogen fuel cell may be configured to provide direct current (DC) electrical output and may be operated alone or in combination with one or more power management components, such as inverters, converters, regulators, batteries, capacitors, or other energy storage devices. The hydrogen fuel cell may be sized and arranged to supply continuous, intermittent, or backup electrical power to one or more electrical loads, such as the compressor that may be part of any of the systems disclosed herein.

As used herein, the term “off grid” refers to locations which are not connected to one or more public utilities including, but not limited to, electricity, gas, and water. As used herein, the term “remote” refers to an area which is a distance away from a city, town, or other residential area, and which typically lacks one or more public utilities. In the various configurations of the disclosed systems and methods, the off-grid remote location may be a wellsite.

The term “pneumatic controller” refers generally to a component or system that regulates pressure, flow, or actuation in a pneumatic system using only air or gas as the working medium. Pneumatic controls may include pressure regulators, flow restrictors, or pilot-operated valves and typically operate via mechanical or pneumatic feedback loops without reliance on electronic or digital controllers. While certain aspects of the system are described herein as utilizing a control unit to monitor and switch between the gas supplies, each could also be monitored and executed using pneumatic controllers and devices (e.g., switching and/or control valves, etc.).

As used herein, a “programmable logic controller” or “PLC” refers to an industrial control device comprising one or more processors and associated memory, configured to execute stored instructions to monitor inputs from sensors or other input devices and to generate control outputs to actuators, valves, motors, or other controlled equipment in accordance with a defined control logic. A PLC may include, or be operatively coupled to, input/output modules, communication interfaces, and power supplies, and is adapted to operate reliably in industrial or wellsite environments.

A “remote telemetry unit” or “RTU” refers to a field-deployed control and monitoring device comprising one or more processors and associated memory, configured to acquire data from sensors or other field devices, transmit such data to a remote monitoring or control system, and optionally receive and execute control commands from the remote system. An RTU may include input/output modules, communication interfaces (wired or wireless), power management circuitry, and data logging capability, and is adapted for reliable operation in remote, unattended, or harsh environments, such as wellsites.

As used herein, a “switching valve” may be understood to be a valve configured to direct the flow of compressed gas to different devices or portions of a pneumatic system. Switching valves may be manually actuated, mechanically linked, or pneumatically actuated, and they allow reconfiguration of airflow without requiring an electronic controller.

The term “wellsite” can include any remote site whether a well exists onsite or not. Many processing facilities require instrument air but do not have wells onsite.

### Aspects and Embodiments of the Present Disclosure

The present invention addresses the need for a more robust instrument air system for remote wellsites, i.e., a system using less or no field gas such as methane. While described herein as useful at remote wellsites, the disclosed instrument air system may also be used at any remote site needing compressed gas to run pneumatic equipment, or any site having intermittent or unreliable power that may need compressed gas to run pneumatic equipment. The system may include a primary supply of a first gas and a secondary supply of a second gas and flow lines connecting an output from each of the primary and secondary supplies to an output line connectable to the pneumatic equipment (also referred to herein as a pneumatic device). When the first gas is depleted or nearly depleted, the system causes a flow of gas to the output line to switch from the primary supply to the secondary supply.

When the system is positioned at a wellsite, the first gas may comprise a compressed gas that is not from the wellsite, and the second gas may comprise any of (i) a gas from the wellsite, (ii) a second tank of the first compressed gas, or (iii) a tank of compressed gas that is different from the first gas. For example, the system may comprise an air compressor such that the primary supply may comprise one or more compressed gas tanks, and the first gas may comprise compressed air generated by the air compressor. The second supply may then be a tank of compressed gas not supplied by the air compressor, such as a tank of a compressed air or an inert gas such as nitrogen gas, helium gas, argon gas, carbon dioxide, and any combination thereof.

Because pressurizing a gas storage tank to higher pressures generally requires increased energy, the primary supply may comprise multiple tanks, each charged by the air compressor to a different pressure. For example, when the pneumatic device is a control valve, the compressed gas pressure required to actuate the valve may be in the range of about 70 to 120 psi. In contrast, when the pneumatic device is associated with a well shut-in event, the compressed gas pressure required to actuate one or more associated valves may be about 90 psi or greater. Accordingly, the primary supply may include one or more tanks pressurized to about 120 psi, one or more tanks pressurized to about 70 psi, and/or additional tanks pressurized to other selected pressures based on the requirements of the pneumatic devices to be supplied with compressed gas.

The system may comprise a tertiary supply of a third gas. When the first and second gases of the primary and secondary supplies, respectively, are depleted or nearly depleted, the system may cause the flow of gas to the output line to switch from the primary or secondary supply to the tertiary supply. As example, when the system is positioned at a wellsite, the first gas and the second gas may each independently comprise a compressed gas that is not from the wellsite, and the third gas may comprise a gas from the wellsite.

In some configurations, the system may comprise an electronic control unit configured to cause the flow of gas to the output line to switch from the primary supply to the secondary supply, such as when the first gas of the primary supply is depleted or nearly depleted. When more than one primary supply is provided, such as various tanks comprising gas compressed at different pressures, the control unit may switch between different tanks of the primary supply based on the pressure requirements of the pneumatic device. In configurations comprising a tertiary supply, the electronic control unit may be further configured to cause the flow of gas to the output line to switch from the primary or secondary supply to the tertiary supply, such as when the first and second gases of the primary and secondary supplies, respectively, are depleted or nearly depleted.

The control unit may be a programmable logic controller (PLC), a remote telemetry unit (RTU), a flow computer, or any combination thereof. The control unit may receive signals from one or more sensors, such as one or more pressure sensors, that report on the pressure status of the primary, secondary, and if included, tertiary supplies.

In some configurations, the system may comprise a pressure-responsive changeover valve configured to automatically cause the flow of gas to the output line to switch from the primary supply to the secondary supply, such as when the first gas of the primary supply is depleted or nearly depleted. When the tertiary supply is included, the pressure-responsive changeover valve may cause the flow of gas to the output line to switch from the primary or secondary supply to the tertiary supply, such as when the first and second gases of the primary and secondary supplies, respectively, are depleted or nearly depleted.

In either configuration, i.e., a system comprising a control unit or a system comprising a pressure-responsive changeover valve, switching from the first or second or third supply may also be based on the specific pneumatic device being supplied and/or on the gas pressure in the supply as indicated above.

The system may comprise a main power unit that includes one or more solar panels, one or more wind turbines, or a combination thereof. The main power unit may further include a rechargeable main battery array configured to receive power from the one or more solar panels, one or more wind turbines, or the combination thereof.

The system may comprise an auxiliary power unit that includes one or more auxiliary solar panels, one or more auxiliary wind turbines, or a combination thereof. The auxiliary power unit may further comprise an auxiliary battery array configured to receive power from the one or more auxiliary solar panels, one or more auxiliary wind turbines, or the combination thereof. In such a configuration, the system may be configured to select and implement either (i) a main battery mode wherein the air compressor is powered from the main power unit, or (ii) an auxiliary power mode wherein the air compressor is powered via the auxiliary power unit, wherein the main battery mode is selected when a charge of the main battery array is above a predetermined level, and the auxiliary power mode is selected when the charge of the main battery array is below a predetermined level. The control unit may be configured to select and implement either the main battery mode or the auxiliary power mode based on preset values, human input, or dynamically based on power trends (e.g., trends for power supplied by the solar panels and/or wind turbines).

The system may comprise a generator configured to generate an output, wherein, when the system is positioned at a wellsite, the generator is powered by an engine configured to use gas from the wellsite as a fuel, or wherein the generator is powered by an engine configured to use any hydrocarbon. The output of the generator may be directed to the air compressor to power the air compressor when a charge of the main battery array is below a predetermined level, or the output of the generator may be directed to an auxiliary air compressor configured to provide the additional air supply. In some configurations, the output of the generator (or a portion thereof) may be directed to the main battery array.

The system may comprise a fuel cell configured to generate an electrical output, wherein, when the system is positioned at a wellsite, the fuel cell is supplied with hydrogen from an on-site or off-site source. The electrical output of the fuel cell may be directed to the air compressor to power the air compressor when a charge of the main battery array is below a predetermined level, or the electrical output of the fuel cell may be directed to an auxiliary air compressor configured to provide an additional air supply. In some configurations, the electrical output of the fuel cell (or a portion thereof) may additionally or alternatively be directed to the main battery array.

When the system may comprises a generator, it may also comprise at least one inverter connected between the generator and the main battery array, wherein the inverter is configured to convert DC power to AC power and AC power to DC power, and a controller coupled to the inverter, the main battery array, and the generator. The controller may be configured to select and implement either (i.) a battery mode wherein the generator is off, and the air compressor is connected to the main battery array; or (ii.) a generator mode wherein the generator is on thereby powering the air compressor via the at least one inverter and charging the main battery array. The battery mode is selected when the charge of the main battery array is above a predetermined level, and the generator mode is selected when the charge of the main battery array is below a predetermined level.

The present disclosure also provides methods for providing compressed gas to a pneumatic device, such as a pneumatic device used at a remote site. The method generally comprises providing a system having a primary supply of a first gas, a secondary supply of second gas, and flow lines connecting an output from each of the primary and secondary supplies to an output line connectable to the pneumatic device. In the method, the flow of gas to the output line is switched from the primary supply to the secondary supply when the first gas is depleted or nearly depleted, and optionally, the flow of gas to the output line is switched from the primary or secondary supply to a tertiary supply of a third gas when the first and second gas is depleted or nearly depleted.

The method may further comprise operating a solar panel, a wind turbine, or combination thereof to deliver an electrical output to a battery array; and operating an air compressor to provide compressed air to the pneumatic device or to the primary or secondary supplies, wherein the air compressor is powered by the battery array.

When the pneumatic device is for use at a well site, the method may further yet comprise operating a generator to generate an electrical output, wherein generator is powered by an engine configured to use gas from the wellsite as a fuel or any hydrocarbon as fuel. Alternatively, the method may comprise operative a fuel cell to generate an electrical output. The method may deliver the electrical output to a battery array and/or to an electrical device. When the electrical device comprises an air compressor, the method further comprises operating the air compressor to provide compressed air to the pneumatic device or to the primary or secondary supplies.

As disclosed, the systems may provide compressed air from primary, secondary, and optionally tertiary supplies, such as compressed gases, and only when absolutely required, field gas as a failsafe. The disclosed system may provide compressed gas, such as compressed air, produced on-site by a compressor. The energy to run the compressor may be provided by a battery array, such as a battery array that is charged via electrical energy generated via use of alternate energy sources. For example, devices of the present disclosure are designed to include solar and/or wind powered air compressors as a suitable way to displace the use of methane. However, these solar and wind powered systems come with limitations. If there is not enough sun or not enough wind for an extended period, the battery powered air compressor will not be able to produce enough compressed air to operate the equipment, and the well will have to shut in. Further, in the event there is a mechanical, power, or other type of failure with the air compressor and power system, the well will have to shut in. The reliability of the pneumatically controlled equipment is paramount to production from the well and operation of the surface or related processing equipment, including safety devices. Shutting the well in due to failure of this equipment is not economically sustainable for the producer of the well.

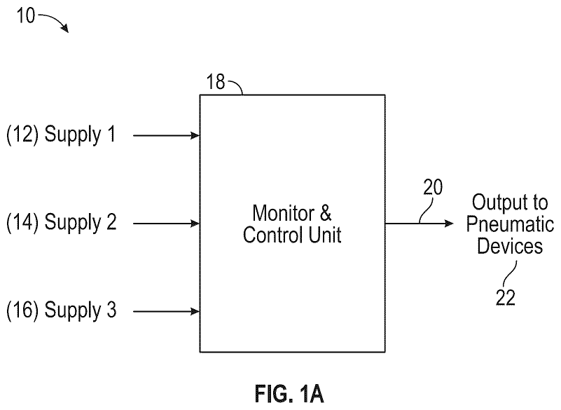

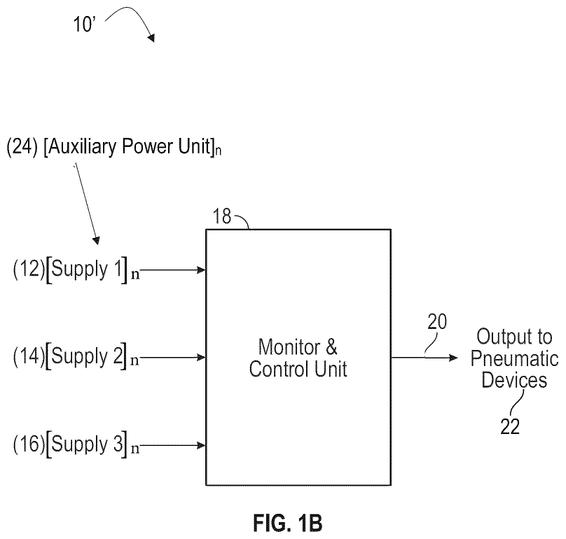

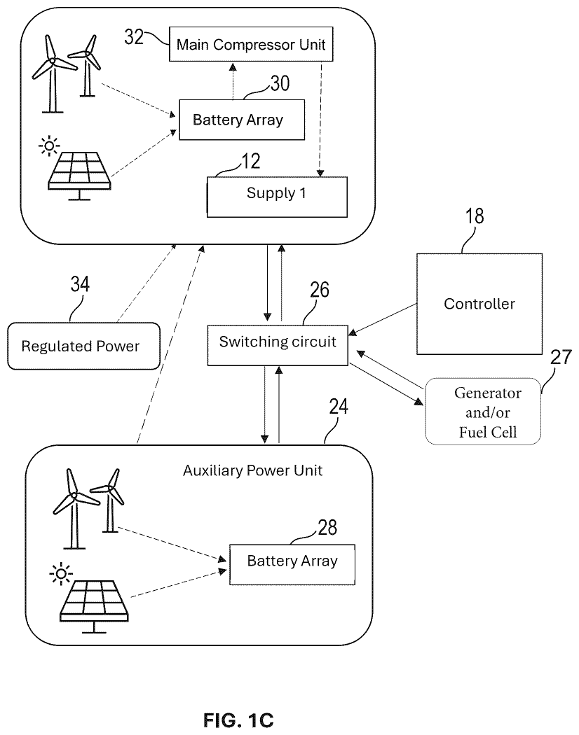

Accordingly, the present disclosure provides a system configured to use solar and/or wind generated energy to power an air compressor, and to additionally use gas from one or more additional sources as backup in the event the solar and/or wind generated energy is insufficient or malfunctions. Such a system is described in more detail herein with reference to FIGS. 1A to 12.

As illustrated schematically in FIG. 1A, the system 10 may include two or more gas supplies (12, 14, 16) useful to power pneumatic devices 22 at a remote site, such as a remote wellsite. A primary supply 12 may be compressed air at a desired pressure, such as generated by an air compressor utilizing solar and/or wind power. If there is insufficient air pressure from the primary supply, a secondary supply 14 of gas can be utilized as backup. The secondary supply 14 may be an available field gas, such as the methane gas currently in use at many wellsites. Alternatively, the secondary supply 14 may be a compressed gas, such as a bottled gas. A tertiary supply 16 of gas may be utilized as a further backup, such as the available field gas. Additional supplies of gas may be provided such that the system may include more than three possible supplies, e.g., a fourth or more supply of gas useful to power pneumatic devices 22 is possible and within the scope of the present disclosure. Each supply of gas (e.g., 12, 14, 16) may comprise one or more tanks of gas, such as one or more tanks of compressed air, oxygen, or an inert gas such as nitrogen, carbon dioxide, helium, argon, and the like (see FIG. 1B).

The ‘switching’ between primary (compressed air), secondary (e.g., bottled gas or field gas), and in certain configurations, tertiary or more (e.g., field gas or bottle gas) supplies is controlled by a control unit 18 or other pneumatic devices. Such a system design is particularly novel because sizing up air compressor systems and their power supplies to ensure reliability can be prohibitively costly. Furthermore, without reliability, the wellsites can experience costly downtime, or even lack of actuation of safety shut down systems, which may cause greater emissions and consequences for the operator such as fines. The switching enables a high degree of reliability without the need to super-size the air compressor system to achieve it, thus minimizing the probability of equipment failure, downtime, and fines.

Power to operate the air compressor used to generate the primary supply 12 of gas may be provided by alternate power sources, such as solar and/or wind power. As shown in FIG. 1C, a main battery array 30 may receive power from one or more solar panels and/or one or more wind turbines. The main battery array 30 may power the main compressor unit 32, which supplies compressed air to the primary supply 12. Should power provided by the alternate power sources be insufficient to power the air compressor, i.e., a charge state of the main battery array 30 is insufficient, the system may switch to use of the secondary supply 14 of gas. Should the secondary supply 14 of gas be insufficient, e.g., insufficient pressure or volume, the system may switch to use of the tertiary supply 16 of gas, and so on (e.g., fourth, fifth, etc., supplies of gas).

With reference to FIGS. 1B and 1C, in some configurations of the disclosed system 10′, an auxiliary power unit 24 may be included, which may provide power to the primary supply 12 of gas, such as the air compressor 32, when power from the primary power source is depleted (i.e., main battery array 30). For example, in the event the primary power source to the air compressor is insufficient, e.g., solar and/or wind generated power stored in the main battery array 30 is insufficient, power from the auxiliary power unit 24 may be routed to the air compressor 32. Such units (24) may comprise an auxiliary battery array 28 charged via solar panel(s) and/or wind turbine(s). The disclosed system may also include a generator 27. In the event the primary power source to the air compressor is insufficient, e.g., solar and/or wind generated power stored in the main battery array 30 is insufficient, the generator 27 may be used to directly power the air compressor and/or may also be used to charge the main and/or auxiliary battery arrays.

The generator 27 may be configured to selectively provide AC or DC power to the air compressor. The air compressor may be selectively coupled to or decoupled from the generator such that power is delivered to the air compressor only when compression is required. By way of example, coupling and decoupling may be achieved using an electrically actuated clutch, a belt-and-pulley system with a clutch or tensioning mechanism, a gearbox or transmission with a selectable engagement mechanism, a direct-drive coupling with an electromagnetic clutch, a hydraulic or pneumatic coupling, or an electrical coupling in which electrical power from the generator is selectively routed to the air compressor. The generator may alternatively or additionally be configured to supply DC power that is stored in a bank of batteries designed to provide backup power to the air compressor, such as a main and/or auxiliary battery array.

The generator may be a gas-powered generator, such as a generator designed to use any known hydrocarbon (gasoline, propane, etc.) or to use a gas from the wellsite, such as methane. When the power level from the main battery array 30 of the main compressor unit 32 is below a threshold, a switching circuit 26 may switch the power source to the auxiliary battery array 28 of the auxiliary power unit 24 or to regulated power 34 or to a secondary power supply such as a generator to provide uninterrupted power to the main compressor unit 32 to generate the primary supply 12.

Additionally, or alternatively, power may be provided by a regulated power supply 34 originating from a standard AC source useful to power the compressor, or that may be converted to a well-regulated DC output useful to charge a battery array. As discussed, certain regions may have access to a regulated power supply that is unreliable. As such, the disclosed system may be useful to provide a backup source of alternative power and/or compressed gas useful to drive pneumatic devices.

The system may utilize gases from a variety of sources to provide instrument air. For example, the system may utilize compressed gas as the primary supply (12), such as air or an inert gas, e.g., nitrogen, with methane as the secondary supply (14), such as pulled from the wellsite. Alternatively, compressed air, such as generated via an air compressor 102, could be the primary supply (12) with an inert gas, e.g., nitrogen, as the secondary supply (14), and methane as the tertiary supply (16). This configuration, and any other multi-gas configuration, e.g., fourth, five, etc. supply, allows for more redundancy before requiring the use of methane as the final and last resort gas supply or shutting down the wellsite.

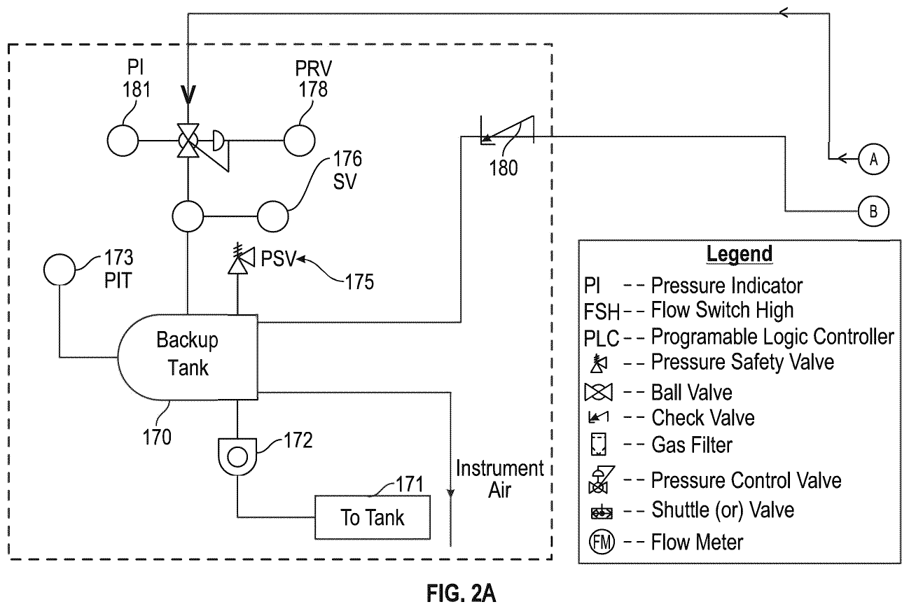

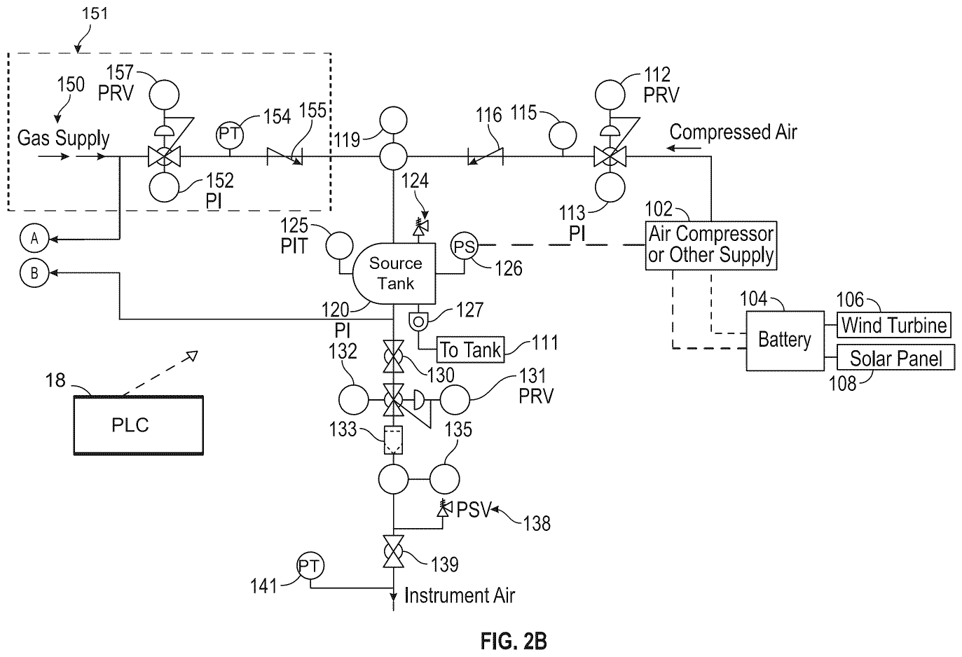

With specific reference to FIGS. 2A and 2B, the system may utilize compressed air generated by an air compressor 102 as the primary source, and may utilize gas from sources 150 such as compressed gas tanks and/or field gas from a wellsite (e.g., methane) as secondary, tertiary, or more supplies. In certain configurations, methane may not be used at all. There can be a primary supply (12, e.g., compressed air generated by the air compressor) and a secondary supply (14, e.g., nitrogen 150) with the secondary gas usage minimized. The usage is prioritized such that any number of any type of gas can be used with the proviso that the last gas has the least priority, and its usage is minimized and preferably never used but available if needed.

With specific reference to FIG. 2B, compressed air, such as generated by an air compressor 102 that is powered via one or more batteries 104, may be directed to a source tank 120. The batteries 104 may store energy generated by one or more wind turbines 106, one or more solar panels 108, or both. Standard components of a solar or wind powered battery that are well known in the art may be included, such as inverters, charge controllers (e.g., MPPT), and the like.

The compressed air in the source tank 120 may be used to provide instrument air to pneumatic devices at a remote site. A pressure of the air or gas transmitted to the pneumatic devices may be monitored via a control unit 18 based on signals from a pressure transmitter 141. Between the primary tank 120 and the pneumatic instruments, the pressurized air or gas may be filtered 133 and/or have additional water/liquids removed via a dryer or other means. Further, various valves on the flow line extending from the primary tank 120 to the pneumatic devices (e.g., valves 130 and 139) may be actuated to open or close based on signals sent from a main control unit (18) and/or controller connected directly to the valves. For example, a control unit opening and closing a valve 131 based on signals from any of the pressure transmitters (141, 125, 154, or 115). A pressure safety valve 138 may be included on the flow line to ensure excessive pressure is not transmitted to the pneumatic equipment.

With continued reference to FIGS. 2A and 2B, pressure regulators (112, 157) with different setpoints allow the primary supply (e.g., compressed air in source tank 120) to be utilized until the pressure from the primary supply dips below a threshold pressure setpoint, at which time the gas will be sourced from a secondary supply (e.g., field gas such as methane from 150, utilizing pressure regulator 157). The secondary supply is directed to the source tank 120 to provide the instrument air. Check valves (116, 155) from the primary and secondary supplies, respectively, may be included to restrict backflow of the gases. As noted in FIG. 2B, the components 151 may be provided in duplicate or more to accommodate the various gas sources, e.g., tertiary supply, or more.

In certain configurations, such as the configuration just described, a valve 119 joining the two supplies may not be required. Such a configuration allows for primary usage of fresh air with the secondary or tertiary supply use available only when failure occurs of the proceeding gas supply as determined by preset pressure regulators, thus minimizing the use of methane. Monitoring and quantifying the volume of each without meters and additional instrumentation in this configuration may be challenging. Thus, additional equipment may be included in the system to measure or estimate the volume of one or multiple streams of gas. For example, valve 119 may be included and may be a shuttle valve or other pneumatic device, which shifts to an open position to allow only the gas to flow that has the highest pressure. The control unit would know which gas is being used based on signals to the control unit 18, such as received from pressure transmitters (115, 154; respectively) or flow switches. Alternatively, valve 119 may be a 3-way solenoid that switches based on appropriate criteria such as pressure. Utilizing flow switches or pressure transmitters (154 and 115; respectively) in communication with the control unit 18, the flow time for each gas can be determined.

In the absence of flow meters, the run time of the air compressor 102 and its associated flow curve can be utilized to determine, over an extended time, the demand (flow rate) of the site, such as via control unit 18. This can then be utilized at any time to approximate the volume of each gas based on the flow time of the dominant supply. A flow switch located upstream of valve 119 of all supply streams that is monitored by the control unit 18 may more accurately estimate gas usage using this method by specifically only counting the time of flow of each gas. Alternatively, a pressure transmitter, e.g., 154 or 115, that indicates which gas is available to flow may be used to approximate usage of each gas. However, in this latter configuration, additional assumptions may need to be made.

To more accurately measure the gas, a single flow meter may be utilized as shown 135, which is preferably downstream of the primary tank 120 and at the lowest pressure as the gas leaves the system. Alternatively, a single meter may be utilized on the line coming from the supply of gas 150. For example, when the secondary supply is compressed gas from a tank or well gas (e.g., from source 150), a single meter may totalize the volume of gas utilized. Alternatively, when the secondary supply is from a backup tank 170, a single meter positioned on the output flow line of the tank may totalize the volume of gas utilized. Further yet, utilizing a shuttle valve (simplest) or a 3-way solenoid valve (more control) 119, the control unit 18 may register the gas type based on a position of the valves and may totalize the volume with the single meter 135. The single meter may have selectable gas calibration curves that are triggered by the control unit 18 as to which gas type to use (e.g., such as via MODBUS communications or hardwire inputs).

Alternatively, the meter 135 may utilize a single gas type calibration, and the control unit 18 would compensate (e.g., scale) for the different gas properties to determine the approximate totalized volumes of the two (or multiple) different gases. Further yet, emissions from methane or other carbon-based gas may be measured using a flow meter in each source line. The collected data may be reported in the appropriate time frame and format as needed for EPA reporting or otherwise.

The system 10 can utilize a volume tank or multiple volume tanks to optimize the start/stop and runtime of the compressor 102 while also providing sufficient volume for high demand needs and facilitating liquid removal. Currently, emergency shut down (ESD) devices and select other items are not included in the regulations to reduce methane emissions. Some pneumatically controlled ESD valves and other equipment may require a large volume of gas to actuate and/or may require a higher pressure than all other pneumatically controlled equipment. As such, a backup tank 170 may be included, wherein the backup tank is configured to include both or either of fresh air from the air compressor (102) or a gas sourced from 150 any of a compressed gas tank (e.g., N₂) or field gas (e.g., methane) depending on the system status, thus providing sufficient pressure to supply the EPA regulated equipment.

With specific reference to FIG. 2A, a backup tank 170 may be committed to the non-EPA regulated equipment. The high-volume demand and potentially higher pressure can be sourced from either methane or other gas supply (150). Examples of a device commonly found at a remote site that may require higher pressure and/or a large volume of air is a pneumatically actuated valve used as an emergency shut down valve. Multiple tanks may be utilized in various configurations to fulfill the needs of the site.

According to certain aspects, the system can be configured such that even the backup tank 170 is predominately filled with fresh air from the source tank 120 and air compressor 102 to minimize the use of methane or other compressed gas (see stream of gas from compressor 102, with check valve 180 included to restrict backflow of the gas to the compressor). As such, methane would only be required when the supply of fresh air is not available, when high demand exceeds the supply capability of the fresh air tank, or when the demand exceeds the pressure availability of the fresh air tank. As example, the flow of the methane (from 150) may be blocked from entry to the backup tank 170 for a period while it fills from the air from the compressor and source tank 120 (line B) up to a maximum pressure as indicated by a pressure transmitter or when the pressure equalizes after a set period of time passes. If additional pressure is required in the backup tank 170, such as indicated by pressure transmitter 173 via control unit 18, a solenoid valve 176 under the control of a control unit 18 (or other pneumatic device not requiring a controller) may open to top the tank off to the desired pressure with a gas sourced from the secondary or tertiary, etc. supply (150 through line A; e.g., methane or other gas). Flow of gas into the backup tank 170 may be controlled via a regulator 178 based on pressures in the backup tank 170 monitored via a pressure transmitter 173. The general objective is to further minimize the use of methane by maintaining one or more tanks with pressurized gas, such as air provided by the air compressor, or another gas provided via bottled gas.

This configuration and logic can be extended from the primary to secondary to tertiary tanks, i.e., supplies of gas, to maximize use of the gas from the primary supply and progressively minimize the use of subsequent gases from secondary, tertiary, or greater supplies, ultimately minimizing or eliminating the use of methane. Moreover, as mentioned above, the source tank may be filled with compressed gas from the compressor 102 to a specific pressure, and additional source tanks (not shown) may be included that are filled with compressed gas from the compressor 102 to different pressures. Should the source tank 120 require increased pressure, compressed air from the air compressor 102, or alternatively, compressed air stored on the additional source tanks (150) may be used to increase the pressure in the source tank 120. The additional source tanks may be attached to the source tank 120 directly (i.e., flow lines from the source tank 120 to each additional source tank) or in sequence.

The backup tank 170 may not be required at all depending on the pressure and availability of the methane source or other gas 150, fresh air from compressor 102, and regulatory restrictions. For example, the backup tank 170 may exclusively supply gas to the non-EPA regulated equipment or feed back to the primary system in the event of high demand.

Each of the tanks for the primary supply 12 and secondary supply 14 may include a pressure indicator/transmitter (173, 125; respectively) in communication with the control unit 18 to monitor a tank pressure and control flow of gases to/from each tank. A pressure safety valve (124, 175) may be included on each of the source tank 120 and backup tank 170, respectively. Moreover, while each of the source tank 120 and backup tank 170 store gases, they may also act to remove liquids from the various gas streams due to compressing the gas. A liquid float valve or solenoid valve (127, 172; respectively) may be utilized to automatically drain these tanks. In the event the tank is fresh air only, water could be drained to an evaporating tray or tank (e.g., 111, 171; respectively). If the tank has gas from a wellsite, condensed liquid hydrocarbons may exist and would need to drain to an onsite production tank (not shown).

As shown in FIGS. 1B and 1C, the disclosed system may include an auxiliary power unit 24 comprising one or more solar panels, one or more wind turbines, or both. The auxiliary power unit generates power, which is stored in one or more batteries (e.g., auxiliary battery array) to function as a backup should the primary power source (e.g., main battery array; 104 or FIG. 2B) fail or not provide sufficient power.

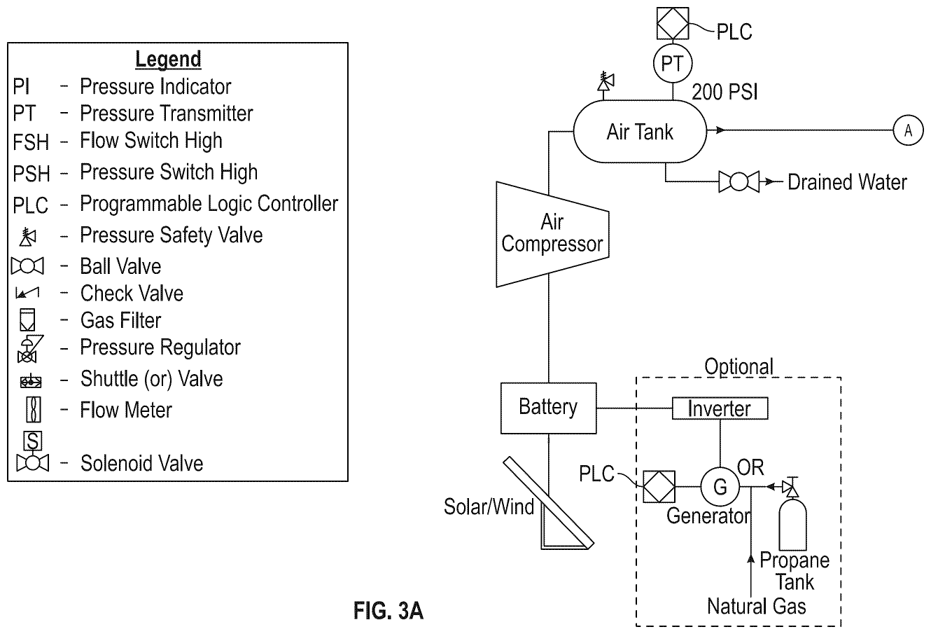

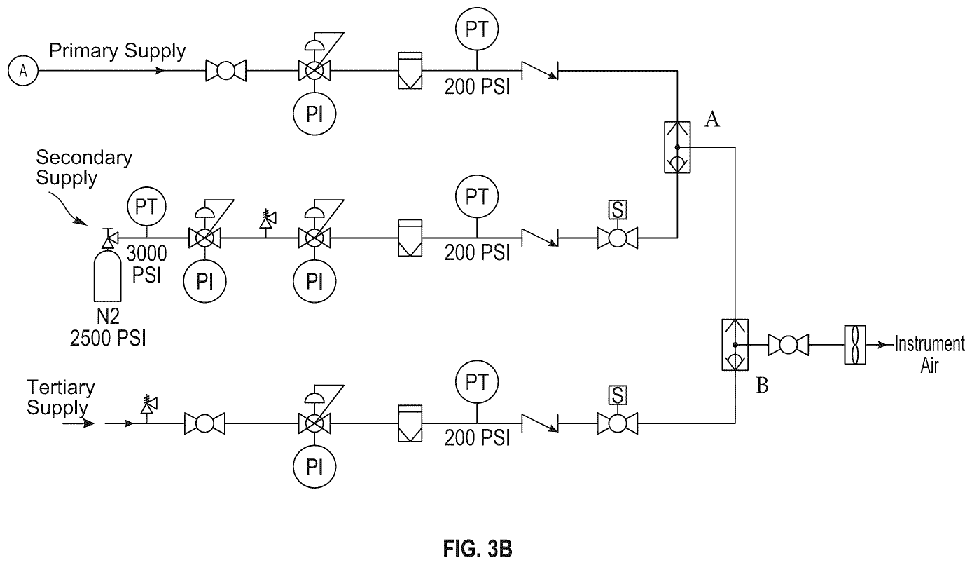

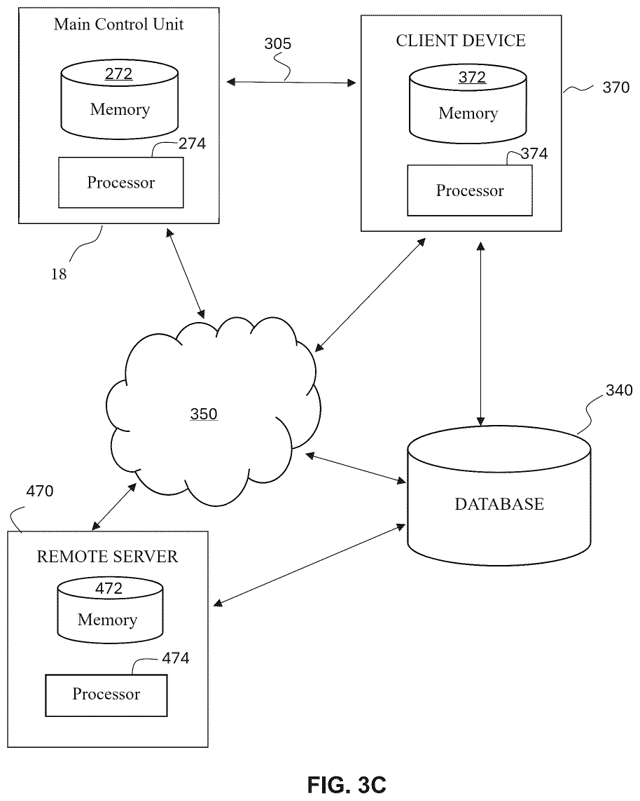

With reference to FIG. 3A, batteries of the main power unit (main battery array) may be directly connected to the air compressor, wherein a control unit switches the power source for the air compressor based on a charge state of the main battery array. For example, and as mentioned above, a secondary auxiliary battery array may be used to power the air compressor. Additionally, or alternatively, the air compressor may also be powered via a generator, such as a generator powered by an engine configured to use the natural gas from the wellsite or from a tank (e.g., propane tank). As shown in FIG. 3B, power produced by the generator may be stored to a battery array, e.g., the main battery array. As such, one or more inverters may be connected between the generator output, the main battery array, and the air compressor, wherein the inverter may be configured to convert DC power to AC power and/or AC power to DC power. Additionally, or alternatively, power produced by the generator may be provided to the air compressor directly. While the generator is shown in FIG. 3A as utilizing natural gas or propane, the generator may in fact be configured to use any hydrocarbon source. As mentioned above, the energy used to power the compressor or charge the battery arrays (main or auxiliary) may be provided by a fuel cell.

With reference to FIG. 3B, an exemplary configuration of the disclosed system is illustrated, which includes primary, secondary, and tertiary supplies. For example, the primary supply may be a fresh air supply provided by an air compressor, a secondary supply may be provided by a bottled gas such as nitrogen. Both the gas from the primary supply and the secondary supply may be filtered prior to use as instrument air. As described next, valves A and B may be configured to provide control without the need of a control unit but instead completely using pneumatically controlled components while still maintaining the desired sequence of prioritization of the gas supplies. This is particularly useful as a “failed state” configuration if power fails. The pressure regulators would have a regulation setpoint with highest pressure on the primary gas supply and decreasing setpoints to the final supply option. If the primary gas pressure drops below the setpoint of the secondary gas, a valve, such as the shuttle valve (A), will shift the gas supply to the secondary supply.

In the event the primary and secondary gas are unable to provide adequate supply based on pressure, a tertiary supply may be used, such as natural gas from a wellsite. As illustrated, a valve, such as a shuttle valve (B), or other pneumatic switching device, may shift to an open position to allow gas flow from the highest-pressure supply. In our example of failed primary and secondary gas supplies, the shuttle valve (B) would shift due to the higher pressure from the tertiary supply and allow the tertiary supply to be the active supply. For additional control, 3-way solenoids could be used in place of the shuttle valves. Further, 2-way solenoids could be used on each supply line upstream of the switching valve to add additional control and if properly configured could still achieve the desired “failed” state. Various valves, pressure regulators, flow meters, and controllers may be included to control the flow of gas from any of the primary, secondary, or tertiary supplies.

A main control unit in any of the disclosed systems may have built in intelligence that allows for optimized local control, remote monitoring, and reporting. As such, remote sensing equipment, such as a fire eye or methane monitor, may be mounted on the air compressor system in an elevated position to add additional monitoring of methane leaks at the facility. Alarms may be sent out through a supervisory control and data acquisition (SCADA) system notifying the operator of leaks. Moreover, such a system may offset the need for some onsite physical inspections as per EPA.

The operating logic of the disclosed system offers several advantages. The system may be operated to maintain operating air pressure, such as within defined pressure limits. As mentioned above, the system may further quantify and report emissions reduction data, by use of non-methane gas versus field gas. As example, the system may calculate and report percent usage of air versus field gas to ensure compliance with regulation(s). Moreover, the system may quantify and report emissions data while operating on field gas.

The disclosed system includes a fail-safe ‘switching’ capability, such as switching from air generated by the compressor to field gas to continue seamless operation of the equipment, such as critical safety devices, if air pressure is lost (a minority of the time). The operating logic provides for continuous monitoring of flow rates and sources via any of the methods discussed above. As such, the system may be configured to send alarms when the percent utilization of field gas has exceeded EPA levels, including early alarms of trending in that direction.

The disclosed system may utilize redundant air compressors to add reliability and volume as required. Status of compressors and the system can be reported and monitored via SCADA. Historical run data and flow rates can be utilized automatically to establish a baseline of demand and low flow scenarios. From this a minimum instantaneous flow rate can be determined and utilized to determine when a leak exists in the field equipment and piping system. This allows for additional monitoring and notifications to minimize methane emissions.

The disclosed system offers several additional benefits beyond a reduction in use of well gas. Such benefits include at least guaranteed compliance with EPA regulations, remote monitoring without the need for technicians to mobilize to remote wellsites, and periodic inspections and testing performed remotely. Because of internal diagnostics and health monitoring capabilities of the system, inspections and tests at the wellsite can be accomplished remotely, and through communication of data, rather than physical wellsite visits.

FIG. 3C illustrates a generalized example of a suitable computing environment (18 370) in which the disclosed system and methods can be implemented. For example, all the control unit implement functions described herein can be implemented by specialized software algorithms stored on a memory 272 of a control unit 18 and executed by a processor 274 thereof. Alternatively, only basic functions may be implemented by specialized software algorithms executed by the control unit 18, such as basic functionality, e.g., receiving signals from individual controllers such as programable logic controllers of the various sensors (pressure indicators), flow meters, etc., and sending signals to open or close various valves. The system 10 may include specialized software executable on a client device 370 having at least a memory 372 and a processor 374. Communication between the control unit 18 and the client device 370 may be via the cloud 350 or a local area network or direct hardwired connection. As such, the system 10 may include a network connection enabling wired or wireless connection to the client device 370 and/or to a remote server 470.

The client device 370 may be a client computing environment comprising specialized software algorithms that are installed locally, such as stored on local client memory 372 of the client device 370 and executed on a client processor 374 using the instructions stored on the client memory 372. Alternatively, or additionally, the computing environment may be a remote server computing environment 470 (computing cloud) wherein computer-implemented functions are executed on a server processor 474 using instructions stored on a server memory 472. A user may access the remote server computing environment 470 from their client device 370 and/or from a user panel on the main system hardware.

Data related to usage volumes, rates, timing, etc. of one or more of the gases provided by the system to the pneumatic devices may be stored locally on a memory 372 of the client device 370, remotely on a memory 472 of the remote server 470, and/or on a centralized database 340.

The computing environment is not intended to suggest any limitation as to scope of use or functionality of the technology, as the technology can be implemented in diverse general-purpose or special-purpose computing environments. For example, the disclosed technology can be implemented with other computer system configurations, including handheld devices, multiprocessor systems, microprocessor-based or programmable consumer electronics, network PCs, minicomputers, mainframe computers, and the like. The disclosed technology can also be practiced in distributed computing environments where tasks can be performed by remote processing devices (470) that can be linked through a communications network (350). In a distributed computing environment, program modules can be located in both local memory (272) and remote memory (372, 472).

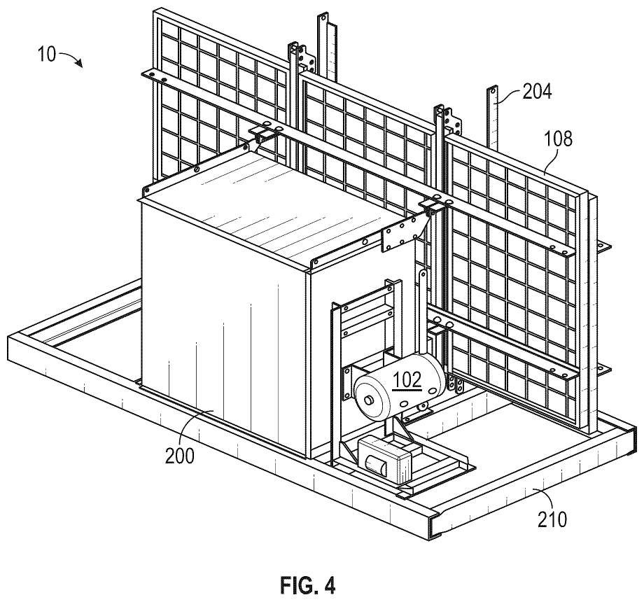

With reference to FIGS. 4 through 7, an exemplary arrangement of the various system components is illustrated. As shown, the system 10 may be provided on a skid 210 or platform. The system may comprise a main housing 200 configured to contain the flow lines, gas tanks, control unit, and various other components, such as valves, sensors, electronics, and the like. Also provided on the skid may be a means for providing alternative energy to the air compressor, such as one or more solar panels and/or wind turbines. In the implementation illustrated in the figures, two solar panels 108 are shown to be supported by a frame 204.

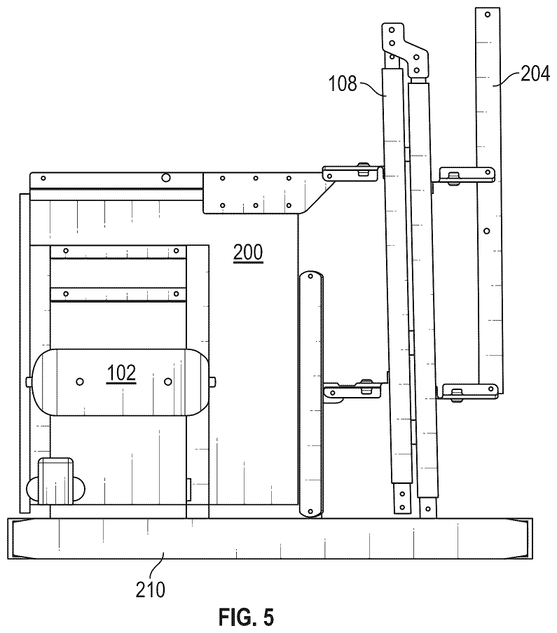

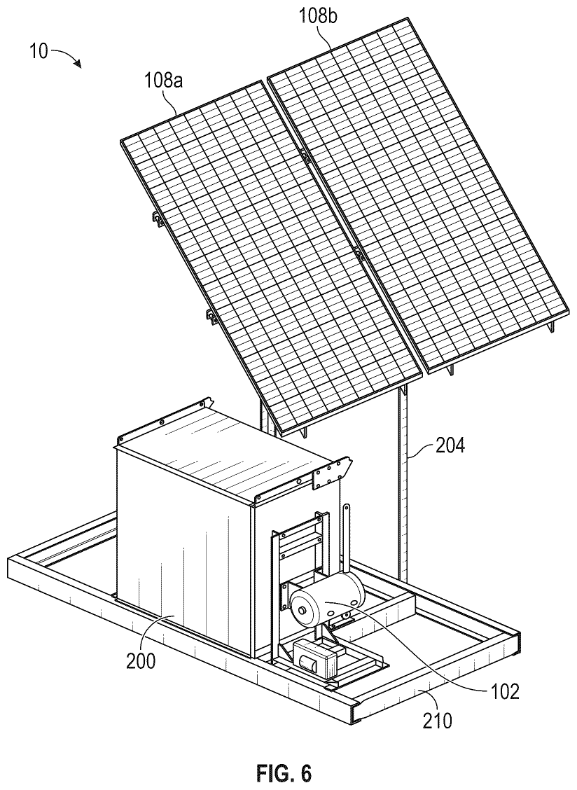

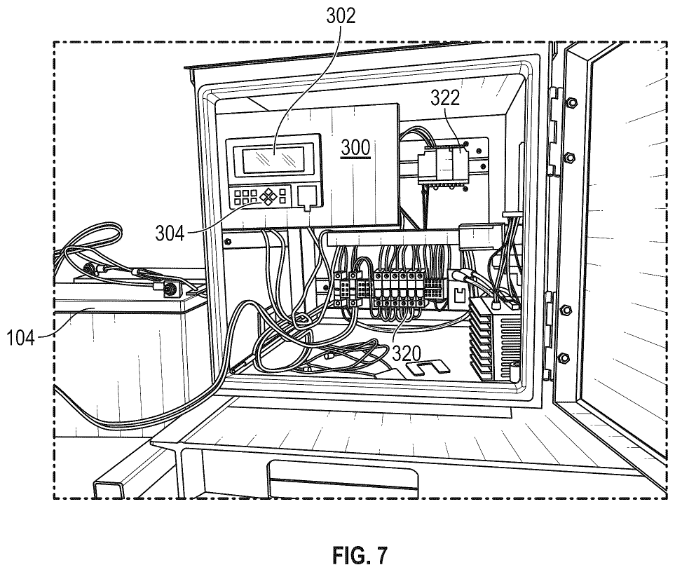

The frame may fold down during shipping of the system to a remote site (FIGS. 4 and 5), such as a wellsite, and may extend to position the solar panels to face the light source (108a, 108b; FIG. 6). Movement of the solar panel 108 on the frame 204 may be manual or automatic, such as controlled remotely from a user device (e.g., client device) or via a user access panel linked to the control unit that is part of the system (e.g., main control unit). For example, FIG. 7 illustrates an electronics cabinet positioned within the housing 200 in which the main control unit 300 is shown as having a user interface, e.g., a display screen 302 and keypad 304. Thus, in some configurations, the system may comprise a human-machine interface. An interface is a user interface or dashboard that connects a person to a machine, system, or device. The interface may communicate with the controller main control unit 18 to receive and display information related to the status of the various gas sources (primary, secondary, tertiary), the compressor, the battery array, the solar panels and/or wind turbines, and/or the generator. For example, the interface can be used to visually display, track, and/or monitor data relating to the operational status of the system and/or its various components. The interface can also be used to visually display one or more alerts related to status of the system and/or the various components. Of note, similar information may additionally or alternatively be transmitted and displayed on an interface of the client server or the remote server.

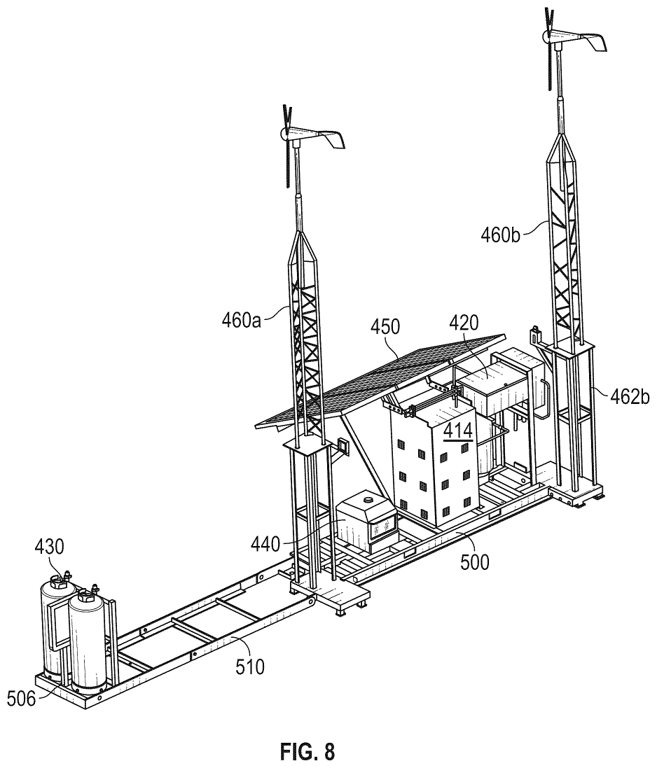

With reference to FIGS. 8 through 12, another exemplary arrangement of the various system components is illustrated. With specific reference to FIG. 8, the system is shown in an operating configuration on a skid 500 or platform. The system may comprise solar panels 450 and/or wind turbines 460a, b that may generate electrical energy that can be stored in a battery array housed within an enclosed housing or battery cabinet 414. The system may include a generator 440, and gas tanks 430 filled with a hydrocarbon gas useful to run a generator. The gas tanks may be positioned on a portion of the skid 510 that extends away from the main system components. Also shown in the housing for the compressor 420, beneath which the source tank 422 (source tank 120) would be positioned, and a housing 402 for various components of the system, such as a gas conditioning equipment check valves, pressure regulators, flow lines, and the like. Not shown are the additional gas tanks that may provide secondary and tertiary, or more, sources of gas. These tanks may be positioned on the skid, typically near the source tank 422.

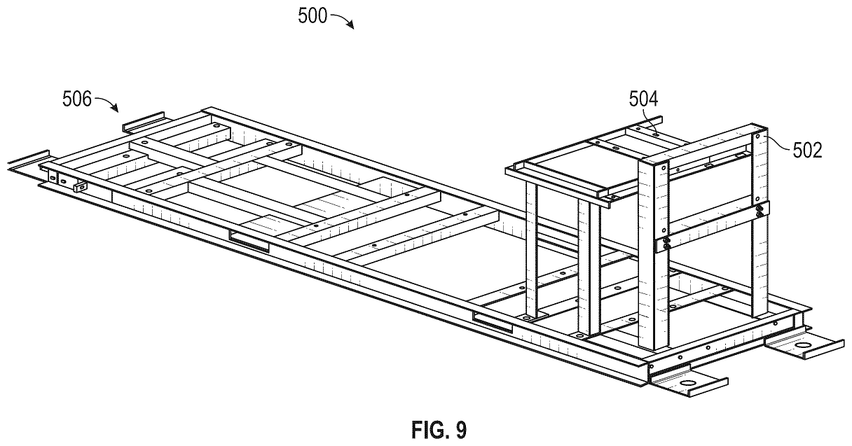

FIG. 9 illustrates the skid 500, having an end 506 that extends outward and which is configured to stably hold one or more gas tanks (e.g., 430). At an opposite end, the skid includes scaffolding configured to accommodate the compressor and its associated valves and flow lines (502) and the battery array (504).

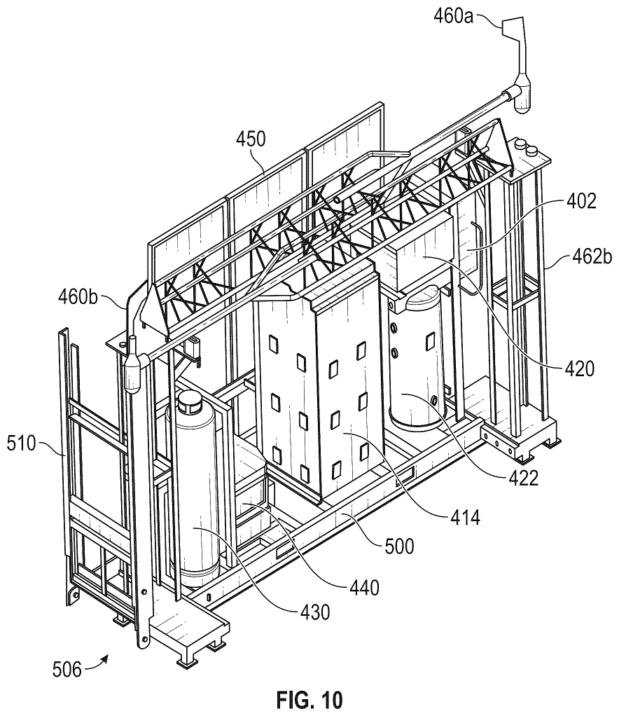

With reference to FIG. 10, the system is illustrated in a compact configuration, suitable for shipping or storage. The end 506 of the skid that previously accommodated the gas tanks 430 is folded upward, wherein the tanks are now positioned on a main region of the skid. The wind turbines 460a are folded inward as are the solar panels 450. Movement of the solar panels 450 and/or wind turbines 460a, b on the skid 500 may be manual or automatic, such as controlled remotely from a user device (e.g., client device) or via a user access panel linked to the control unit that is part of the system (e.g., main control unit). This movement includes extending or folding the components to an “in use” or “stored” position, and/or specific positions of the solar panel and/or the blades of the wind turbines to optimize their energy production, i.e., such as based on sensor input (direction of sun, wind speed and direction, etc.).

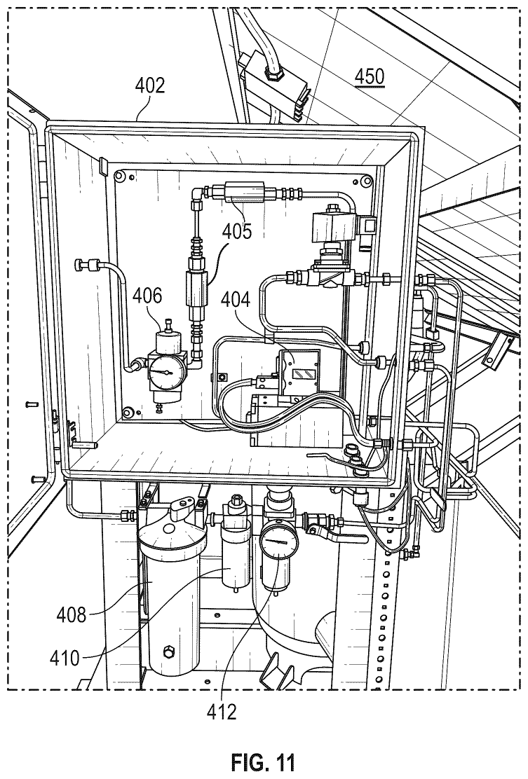

FIG. 11 illustrates the housing 402 comprising various components of the system, including the conditioning equipment for the compressed gas, which includes a water knockout 412, filter 410, and drier (desiccant, silicone beads, etc.) 408. Also illustrated are the pressure regulator 406 that sets the pressure of the gas to be supplied to the pneumatic device, a flow meter 404, such as discussed above that may be used to register flow volumes, and check valves 405.

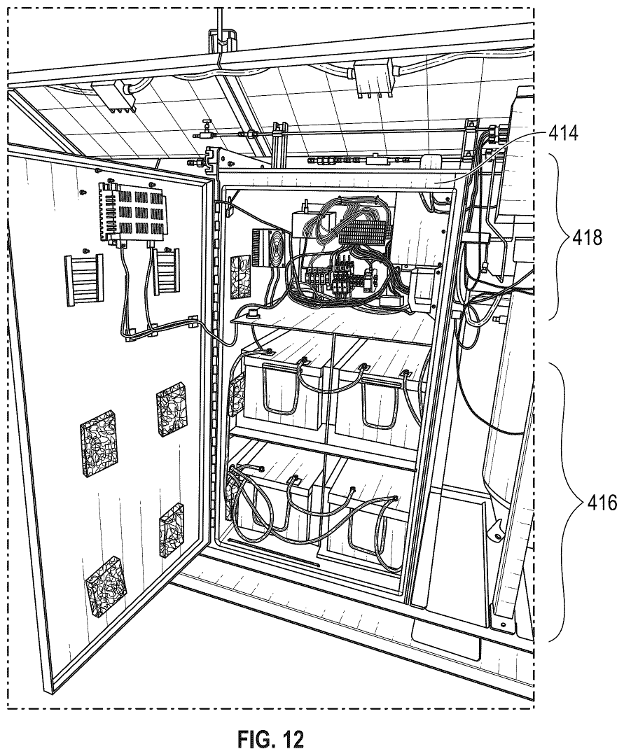

FIG. 12 illustrates the battery cabinet 414 comprising the main battery array 416 and standard components 418 used in alternative energy systems, such as the inverter, MPPT, etc. the battery array may comprise several battery cells electrically coupled to components of the renewable energy source, i.e., the solar panels and/or wind turbines. The battery array may further include one or more charge controllers configured to regulate power received from the renewable energy source and prevent overcharging or deep discharge of the energy storage devices. In addition, the battery array may include power conditioning components such as inverters, rectifiers, and/or DC-DC converters for converting electrical power to a desired voltage or current level for storage or downstream use. Protective and monitoring components, including fuses, circuit breakers, disconnect switches, battery management systems, sensors, and control circuitry, may also be provided to ensure safe and reliable operation.

Accordingly, while particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application, including the appended claims is therefore intended to cover all such changes and modifications that are within the scope of this application.

1. A system comprising:
a primary supply of a first gas;
a secondary supply of second gas; and
flow lines connecting an output from each of the primary and secondary supplies to an output line connectable to a pneumatic device,
wherein, when the first gas is depleted or nearly depleted, the system causes a flow of gas to the output line to switch from the primary supply to the secondary supply,
wherein the first and second gas are not the same, and
wherein the system is configured for use off-grid to provide compressed gas to the pneumatic device.

2. The system according to claim 1, comprising:
a tertiary supply of a third gas,
wherein, when the first and second gases of the primary and secondary supplies, respectively, are depleted or nearly depleted, the system causes the flow of gas to the output line to switch from the primary or secondary supply to the tertiary supply, and
wherein the first, second, and third gases are not the same.

3. The system according to claim 1, wherein, when the system is positioned at a wellsite, the first gas comprises a compressed gas that is not from the wellsite, and the second gas comprises either of (i) a gas from the wellsite, or (ii) a compressed gas that is different from the first gas.

4. The system according to claim 2, wherein, when the system is positioned at a wellsite, the first gas and the second gas each independently comprise a compressed gas that is not from the wellsite, and the third gas comprises a gas from the wellsite.

5. The system according to claim 1, comprising:
an air compressor,
wherein the primary supply comprises a primary tank and the first gas comprises compressed air generated by the air compressor.

6. The system according to claim 1, comprising:
an electronic control unit,
wherein, when the first gas of the primary supply is depleted or nearly depleted, the control unit causes the flow of gas to the output line to switch from the primary supply to the secondary supply.

7. The system according to claim 6, comprising:
a tertiary supply of a third gas,
wherein, when the first and second gases of the primary and secondary supplies, respectively, are depleted or nearly depleted, the electronic control unit causes the flow of gas to the output line to switch from the primary or secondary supply to the tertiary supply.

8. The system according to claim 1, comprising:
a pressure-responsive changeover valve configured to automatically cause the flow of gas to the output line to switch from the primary supply to the secondary supply.

9. The system according to claim 8, comprising:
a tertiary supply of a third gas,
wherein, when the first and second gases of the primary and secondary supplies, respectively, are depleted or nearly depleted, the pressure-responsive changeover valve causes the flow of gas to the output line to switch from the primary or secondary supply to the tertiary supply.

10. The system according to claim 1, wherein each of the primary and secondary supplies of gas independently comprise one or more gas tanks configured to contain compressed gas.

11. The system according to claim 1, comprising:
a main power unit comprising:
one or more solar panels, one or more wind turbines, or a combination thereof; and
a rechargeable main battery array configured to receive power from the one or more solar panels, one or more wind turbines, or the combination thereof.

12. The system according to claim 11, comprising:
an auxiliary power unit comprising:
one or more auxiliary solar panels, one or more auxiliary wind turbines, or a combination thereof; and
an auxiliary battery array configured to receive power from the one or more auxiliary solar panels, one or more auxiliary wind turbines, or the combination thereof,
wherein the system is configured to select and implement either:
(i.) a main battery mode wherein the air compressor is powered from the main power unit; or
(ii.) an auxiliary power mode wherein the air compressor is powered via the auxiliary power unit,
wherein the main battery mode is selected when a charge of the main battery array is above a predetermined level, and the auxiliary power mode is selected when the charge of the main battery array is below a predetermined level.

13. The system according to claim 12, comprising:
a control unit,
wherein the control unit selects and implements either the main battery mode or the auxiliary power mode.

14. The system according to claim 1, comprising:
a generator configured to generate an output,
wherein, when the system is positioned at a wellsite, the generator is powered by an engine configured to use gas from the wellsite as a fuel, or
wherein the generator is powered by an engine configured to use any hydrocarbon gas or well gas.

15. The system according to claim 14,
wherein the output of the generator is directed to the air compressor to power the air compressor when a charge of the main battery array is below a predetermined level, or
wherein the output of the generator is directed to an auxiliary air compressor configured to provide the additional air supply.

16. The system according to claim 15, comprising:
at least one inverter connected between the generator and the main battery array, wherein the inverter is configured to convert DC power to AC power and AC power to DC power; and
a controller coupled to the inverter, the main battery array, and the generator, wherein the controller selects and implements either:
(i.) a battery mode wherein the generator is off, and the air compressor is connected to the main battery array; or
(ii.) a generator mode wherein the generator is on thereby powering the air compressor via the at least one inverter and charging the main battery array,
wherein the battery mode is selected when the charge of the main battery array is above a predetermined level, and the generator mode is selected when the charge of the main battery array is below a predetermined level.

17. The system according to claim 1, wherein utility power is utilized for primary power and the system is used for backup power, or wherein the system is used for primary power and utility power is used for backup power.

18. A method for providing compressed gas to a pneumatic device, the method comprising:
providing a system comprising a primary supply of a first gas, a secondary supply of second gas, and flow lines connecting an output from each of the primary and secondary supplies to an output line connectable to the pneumatic device;
causing the flow of gas to the output line to switch from the primary supply to the secondary supply when the first gas is depleted or nearly depleted, and
optionally, causing the flow of gas to the output line to switch from the primary or secondary supply to a tertiary supply of a third gas when the first and second gas is depleted or nearly depleted.

19. The method of claim 18, comprising:
operating a solar panel, a wind turbine, or combination thereof to deliver an electrical output to a battery array; and
operating an air compressor to provide compressed air to the pneumatic device or to the primary or secondary supplies,
wherein the air compressor is powered by the battery array.

20. The method of claim 18, wherein, when the pneumatic device is for use at a well site, the method comprises:
operating a generator to generate an electrical output, wherein generator is powered by an engine configured to use gas from the wellsite as a fuel or any hydrocarbon as fuel;
delivering the electrical output to a battery array and/or to an electrical device; and
wherein the electrical device comprises an air compressor and the method further comprises:
operating the air compressor to provide compressed air to the pneumatic device or to the primary or secondary supplies.
